(19) United States
(12) Patent Application Publication
(10) Pub. No.: US 2007/0183104 A1
(43) Pub. Date: Aug. 9, 2007

(54) ESD protection device and integrated circuit utilizing the same

(75) Inventor: Jen-Chou Tseng, Hsinchu City (TW)

Correspondence Address: BIRCH STEWART KOLASCH & BIRCH, PO BOX 747, FALLS CHURCH, VA, 22040-0747, US

(73) Assignee: Winbond Electronics Corp.

(21) Appl. No.: 11/453,017

(22) Filed: Jun. 15, 2006

(30) Foreign Application Priority Data
Feb. 9, 2006 (TW) 95104339

(51) Int. Cl. H02H 9/00

(52) U.S. Cl. 361/56

(57) ABSTRACT

An ESD protection device comprising a first switch, a second switch, a discharge unit, and a detection unit. The first switch is coupled to a first power line. The second switch is coupled between the first switch and a second power line. The discharge unit is coupled between the first and second power lines. The detection unit is coupled between the first and second power lines. The first switch is turned on when an ESD event occurs in the first power line. The second switch is turned on when the ESD event does not occur in the first power line.

### BACKGROUND OF THE INVENTION

1. Field of the Invention

The invention relates to a protection device, and in particular to an electrostatic discharge (ESD) protection device.

2. Description of the Related Art

As semiconductor manufacturing processes have developed, ESD protection has become one of the most critical reliability issues for integrated circuits (IC). In particular, as semiconductor manufacturing processes advance into the deep sub-micron stage, scaled-down devices and thinner gate oxides are more vulnerable to ESD stress. Generally, the input/output pads on IC chips are requested to at least sustain 2 kVolt ESD stress of high Human Body Mode (HBM) or 200 Volt of Machine Mode. Thus, the input/output pads on IC chips are usually designed to include ESD protection devices or circuits for protecting the core circuit in IC chips from ESD damage.

FIG. 1a is a schematic diagram of a conventional ESD protection device. Various NMOS transistors are connected in parallel for increasing an ESD tolerance. For clarity, only NMOS transistors 13˜16 are shown in FIG. 1a. Drains of NMOS transistors 13˜16 are coupled to a power line 11. Gates, sources and substrates of NMOS transistors 13˜16 are coupled to a power line 12. When an ESD event occurs in the power line 11 and the power line 12 receives a grounding voltage, ESD current flows through the power line 11, NMOS transistors 13˜16 and finally to the power line 12 to release ESD stress.

FIG. 1b is a top view of a conventional ESD protection device shown in FIG. 1a. When various NMOS transistors are connected in parallel, the resistance between each NMOS transistor and a substrate are different. Thus, the NMOS transistors have various ESD tolerances. For example, resistance of a resistor R_{sub1} coupled between a source S₁₃ of NMOS transistor 13 and substrate 17 thereof is less than that of a resistor R_{sub2} coupled between a source S₁₅ of NMOS transistor 15 and substrate 17 thereof. Additionally, ESD protection device 10 requires a higher trigger voltage (breakdown voltage between a drain and a p-well) such that the ESD tolerance is reduced.

FIG. 2 is a schematic diagram of another ESD protection device. A capacitor 23 and a resistor 24 are serially connected between power lines 21 and 22. An NMOS transistor 25 provides a discharge path and comprises a gate coupled to a point A, a drain coupled to power line 21, and a source coupled to power line 22.

ESD protection device 20 comprises a parasitical BJT transistor 26, which comprises a base coupled to a substrate of NMOS transistor 25, a collector coupled to a drain of NMOS transistor 25, and an emitter a source of NMOS transistor 25. When an ESD event occurs in power line 21 and power line 22 receives a grounding voltage, voltage of point A is increased. Thus NMOS transistor 25 and parasitical BJT transistor 26 are turned on.

FIG. 3 is a schematic diagram of another ESD protection device. Resistor 33 and capacitor 34 are serially connected between power lines 31 and 32. A PMOS transistor 35 and an NMOS transistor 36 constitute an inverter for controlling a NMOS transistor 37. When an ESD event occurs in power line 31 and power line 32 receives a grounding voltage, the voltage of point A is low such that PMOS transistor 35 and NMOS transistor 37 are turned on. Thus ESD current flows through the power line 31, NMOS transistor 37 and finally to the power line 32 to release ESD stress. However, latch-up issues easily occur in the ESD protection device 30 due to the inverter.

### BRIEF SUMMARY OF THE INVENTION

ESD protection devices are provided. An exemplary embodiment of an ESD protection device comprises a first switch, a second switch, a discharge unit, and a detection unit. The first switch is coupled to a first power line. The second switch is coupled between the first switch and a second power line. The discharge unit is coupled between the first and second power lines. The detection unit is coupled between the first and second power lines. The first switch is turned on when an ESD event occurs in the first power line. The second switch is turned on when the ESD event does not occur in the first power line.

Integrated circuits are also provided. An exemplary embodiment of an integrated circuit comprises a first power line, a second power line, and an ESD protection device. The ESD protection device comprises a first switch, a second switch, a discharge unit, and a detection unit. The first switch is coupled to a first power line. The second switch is coupled between the first switch and a second power line. The discharge unit is coupled between the first and second power lines. The detection unit is coupled between the first and second power lines. The first switch is turned on when an ESD event occurs in the first power line. The second switch is turned on when the ESD event does not occur in the first power line.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1a is a schematic diagram of a conventional ESD protection device,

FIG. 1b is a top view of the conventional ESD protection device shown in FIG. 1a;

FIG. 2 is a schematic diagram of another ESD protection device;

FIG. 3 is a schematic diagram of another ESD protection device;

FIG. 4 is a schematic diagram of an exemplary embodiment of an integrated circuit;

FIG. 5a is a schematic diagram of an exemplary embodiment of the detection unit;

FIG. 5b is a schematic diagram of another exemplary embodiment of the detection unit;

FIG. 6 is a schematic diagram of another exemplary embodiment of the integrated circuit; and

FIG. 7 is a comparison sheet of the ESD protection devices.

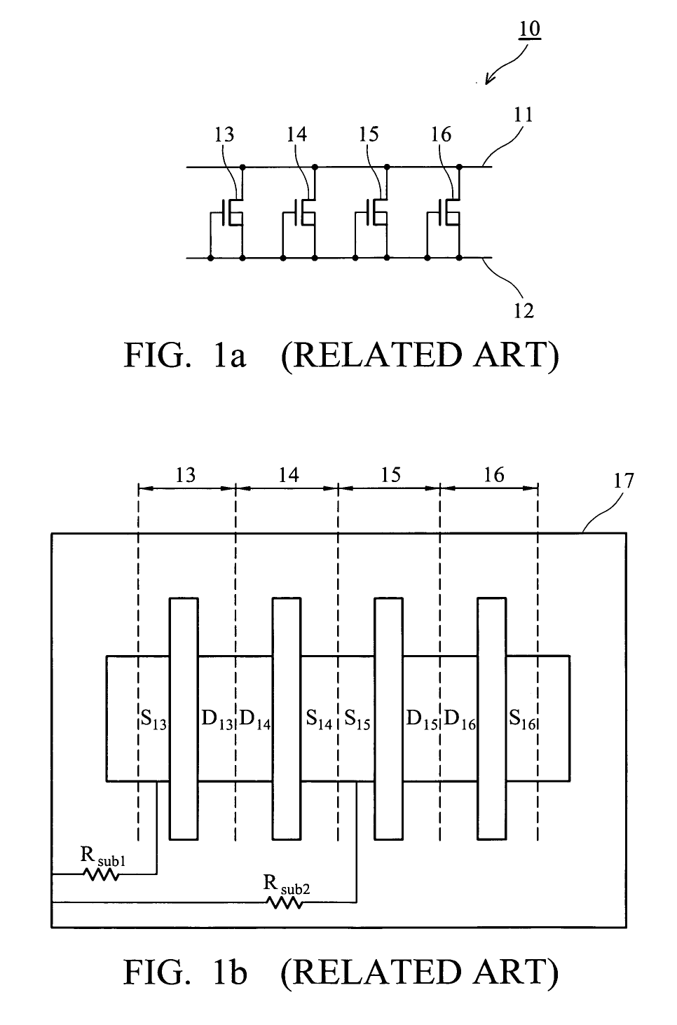

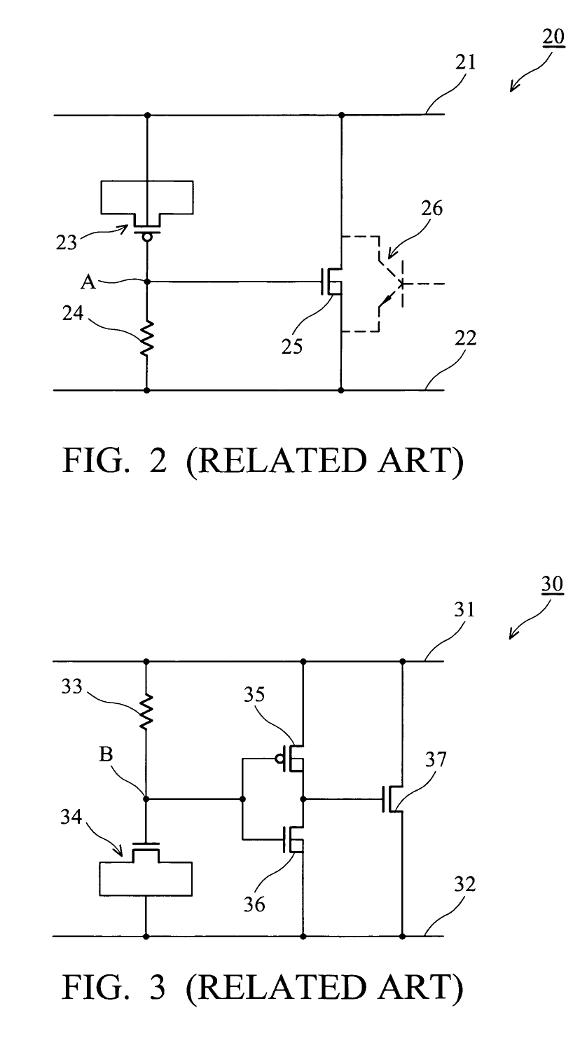

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

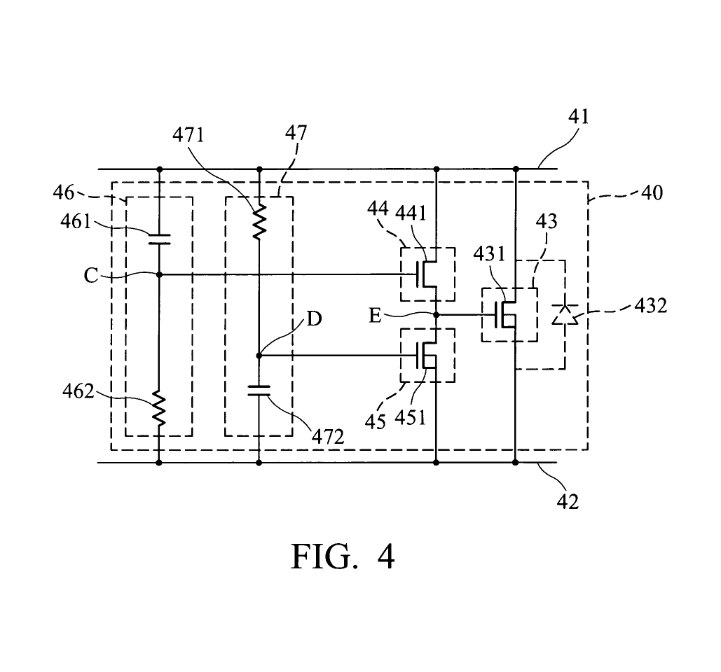

FIG. 4 is a schematic diagram of an exemplary embodiment of an integrated circuit. The integrated circuit utilizes an N-type manufacturing process and comprises power lines 41, 42, an ESD protection device 40 comprising a discharge unit 43, switches 44 and 45, and detection units 46 and 47.

Discharge unit 43 is coupled between power lines 41 and 42. In this embodiment, discharge unit 43 is an NMOS transistor 431. NMOS transistor 431 comprises a drain coupled to power line 41 and a source coupled to power line 42.

Switches 44 and 45 are serially connected between power lines 41 and 42. In this embodiment, switch 44 is an NMOS transistor 441 and switch 45 is an NMOS transistor 451. NMOS transistor 441 comprises a drain coupled to power line 41 and a source coupled to a gate of NMOS transistor 431. NMOS transistor 451 comprises a drain coupled to a source of NMOS transistor 441 and a source coupled to power line 42.

Detection unit 46 is coupled between power lines 41 and 42. In this embodiment, detection unit 46 comprises a capacitor 461 and a resistor 462. Capacitor 461 is coupled between power line 41 and a point C. Resistor 462 is coupled between point C and power line 42. Point C is coupled to a gate of NMOS transistor 441.

When an ESD event occurs in power line 41 and power line 42 receives a grounding voltage, the voltage level of point C is high such that NMOS transistor 441 is turned on. The voltage level of point E is high such that NMOS transistor 431 provides a discharge path. Thus, ESD current flows through power line 41, NMOS transistor 431, and finally to the power line 42 to release ESD stress.

A parasitical diode 432 is generated between a substrate and the drain of NMOS transistor 431. When the substrate of NMOS transistor 431 is coupled to power line 42 and the drain of NMOS transistor 431 is coupled to power line 41, if a negative ESD event occurs in power line 41 and power line 42 receives a grounding voltage, parasitical diode 432 between the substrate and the drain of NMOS transistor 431 is forward turned on. Thus, ESD current flows through power line 41, the drain of NMOS transistor 431, the substrate of NMOS transistor 431 and finally to the power line 42.

Detection unit 47 is coupled between power lines 41 and 42. In this embodiment, detection unit 47 comprises a resistor 471 and capacitor 472. Resistor 471 is coupled between power line 41 and a point D. The capacitor is coupled between point D and power line 42. Point D is coupled to a gate of NMOS transistor 451.

In normal mode (an ESD event does not occur in power line 41), power line 41 receives a high voltage Vdd and power line 42 receives a low voltage Vss such that the voltage level of point D is high. NMOS transistor 451 is turned on and voltage level of point E is low. Thus, NMOS transistor 431 is turned off and the discharge path is not provided for preventing current leakage.

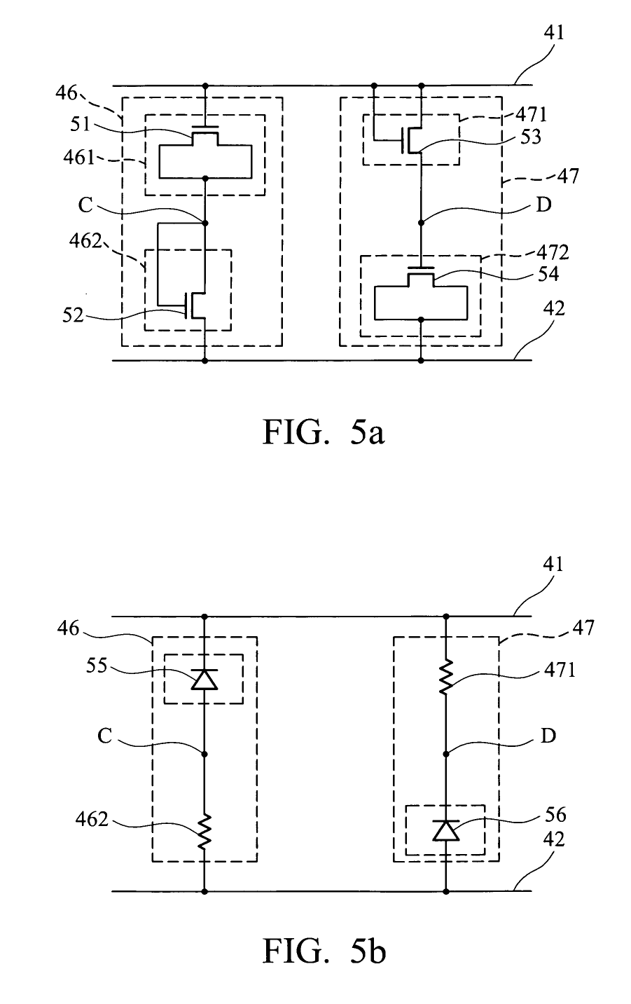

FIG. 5a is a schematic diagram of an exemplary embodiment of the detection unit. Capacitor 461 is an NMOS transistor 51 and resistor 462 is an NMOS transistor 52. NMOS transistor 51 comprises a gate coupled to power line 41, a drain and a source, which are coupled to point C. NMOS transistor 52 comprises a source coupled to power line 42, a gate and a drain, which are coupled to point C.

Resistor 471 is an NMOS transistor 53 and capacitor 472 is an NMOS transistor 54. A gate and a drain of NMOS transistor 53 are coupled to power line 41 and a source of NMOS transistor 53 is coupled to point D. A drain and a source of NMOS transistor 54 are coupled to power line 42 and a gate of NMOS transistor 54 is coupled to point D.

FIG. 5b is a schematic diagram of another exemplary embodiment of the detection unit. Capacitor 461 is a diode 55 and capacitor 472 is also a diode 56. Diode 55 comprises a cathode coupled to power line 41 and an anode coupled to point C. Diode 56 comprises a cathode coupled to point D and an anode coupled to power line 42.

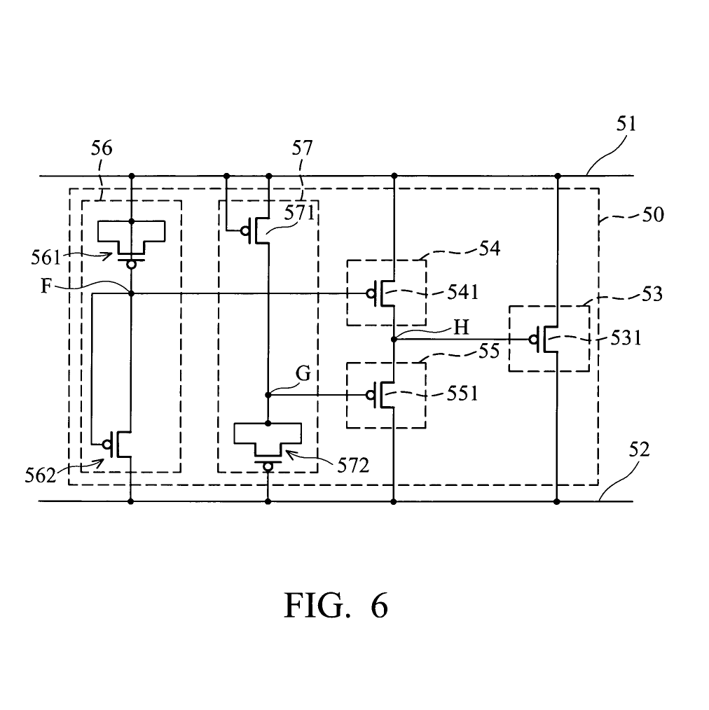

FIG. 6 is a schematic diagram of another exemplary embodiment of the integrated circuit. The integrated circuit utilizes a P-type manufacturing process and comprises power lines 51 and 52 and an ESD protection device 50 comprising a discharge unit 53, switches 54 and 55, and a detection units 56 and 57.

Discharge unit 53 is coupled between power lines 51 and 52. In this embodiment, discharge unit 53 is a PMOS transistor 531. A source of PMOS transistor 531 is coupled to power line 51 and a drain of PMOS transistor 531 is coupled to power line 52.

Switches 54 and 55 are serially connected between power lines 51 and 52. In this embodiment, switch 54 is a PMOS transistor 541 and switch 55 is a PMOS transistor 551. A source of PMOS transistor 541 is coupled to power line 51 and a drain of PMOS transistor 541 is coupled to a gate of PMOS transistor 531. A source of PMOS transistor 551 is coupled to a drain of PMOS transistor 541 and a drain of PMOS transistor 551 is coupled to power line 52.

Detection unit 56 is coupled between power lines 51 and 52. In this embodiment, detection unit 56 comprises a capacitor 561 and a resistor 562. Capacitor 561 is a PMOS transistor comprising a drain coupled to power line 51, a source coupled to power line 51, and a gate coupled to point F. Resistor 562 is a PMOS transistor comprising a gate coupled to point F, a source coupled to point F, and a drain coupled to power line 52.

Detection unit 57 is coupled between power lines 51 and 52. In this embodiment, detection unit 57 comprises a resistor 571 and a capacitor 572. Resistor 571 is a PMOS transistor comprising a drain coupled to point G, a source coupled to power line 51, and a gate coupled to power line 51. Capacitor 572 is a PMOS transistor comprising a gate coupled between power line 52, a source coupled between point G, and a drain coupled to point G.

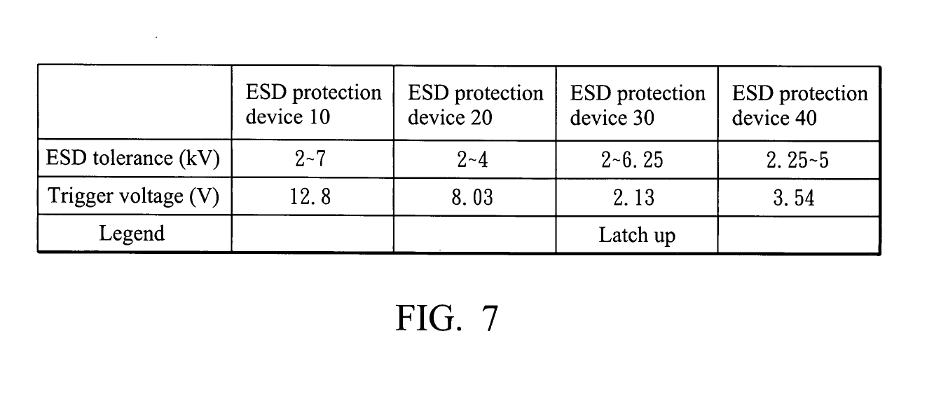

FIG. 7 is a comparison sheet of the ESD protection devices 10, 20, 30, and 40. The trigger voltage of ESD protection device 30 is 2.13V and that of ESD protection device 40 is 3.54V. Although the trigger voltage of ESD protection device 30 is less than that of ESD protection device 40, a latch-up issue occurs in ESD protection device 30. Additionally, the ESD tolerance of ESD protection device 40 exceeds that of ESD protection devices 10, 20, and 30 such that ESD protection device 40 offers better protection.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An ESD protection device, comprising:
a first switch coupled to a first power line;
a second switch coupled between the first switch and a second power line;
a discharge unit coupled between the first and second power lines; and
a detection unit coupled between the first and second power lines, wherein the first switch is turned on when an ESD event occurs in the first power line and the second switch is turned on when the ESD event does not occur in the first power line.

2. The ESD protection device as claimed in claim 1, wherein the discharge unit is an NMOS transistor, or a PMOS transistor.

3. The ESD protection device as claimed in claim 1, wherein the detection unit comprises a first detector comprising a capacitor and resistor, wherein the capacitor is a coupled between the first power line and a first point and the resistor is coupled between the first point and the second power line.

4. The ESD protection device as claimed in claim 3, wherein the capacitor is an NMOS transistor comprising a drain coupled to the first point, a source coupled to the first point, and a gate coupled to the first power line.

5. The ESD protection device as claimed in claim 3, wherein the capacitor is a PMOS transistor comprising a drain coupled to the first power line, a source coupled to the first power line, and a gate coupled to the first point.

6. The ESD protection device as claimed in claim 3, wherein the capacitor is a diode comprising a cathode coupled to the first power line and an anode coupled to the first point.

7. The ESD protection device as claimed in claim 3, wherein the resistor is an NMOS transistor comprising a drain coupled to the first point, a source coupled to the second power line, and a gate coupled to the first point.

8. The ESD protection device as claimed in claim 3, wherein the resistor is a PMOS transistor comprising a drain coupled to the second power line, a source coupled to the first point, and a gate coupled to the first point.

9. The ESD protection device as claimed in claim 3, wherein the first switch is an NMOS transistor comprising a drain coupled to the first power line, a source coupled to the second switch, and a gate coupled to the first point.

10. The ESD protection device as claimed in claim 3, wherein the first switch is a PMOS transistor comprising a drain coupled to the second switch, a source coupled to the first power line, and a gate coupled to the first point.

11. The ESD protection device as claimed in claim 3, wherein the detection unit comprises a second detector comprising a resistor and a capacitor, wherein the resistor is coupled between the first power line and a second point and the capacitor is coupled between the second point and the second power line.

12. The ESD protection device as claimed in claim 11, wherein the resistor is an NMOS transistor comprising a drain coupled to the first power line, a source coupled to the second point, and a gate coupled to the first power line.

13. The ESD protection device as claimed in claim 11, wherein the resistor is a PMOS transistor comprising a drain coupled to the second point, a source coupled to the first power line, and a gate coupled to the first power line.

14. The ESD protection device as claimed in claim 11, wherein the capacitor is an NMOS transistor comprising a drain coupled to the second power line, a source coupled to the second power line, and a gate coupled to the second point.

15. The ESD protection device as claimed in claim 11, wherein the capacitor is a PMOS transistor comprising a drain coupled to the second point, a source coupled to the second point, and a gate coupled to the second power line.

16. The ESD protection device as claimed in claim 11, wherein the capacitor is a diode comprising a cathode comprising to the second point and an anode coupled to the second power line.

17. The ESD protection device as claimed in claim 11, wherein the second switch is an NMOS transistor comprising a drain coupled to the first switch, a source coupled to the second power line, and a gate coupled to the second point.

18. The ESD protection device as claimed in claim 11, wherein the second switch is a PMOS transistor comprising a drain coupled to the second power line, a source coupled to the first switch, and a gate coupled to the second point.
